(19) United States
(12) Patent Application Publication
(10) Pub. No.: US 2026/0331100 A1
(43) Pub. Date: Oct. 22, 2026

(54) INFORMATION PROCESSING DEVICE

(71) Applicant: TOYOTA JIDOSHA KABUSHIKI KAISHA, Toyota-shi (JP)

(72) Inventors: Takayuki YAMABE, Tokyo (JP); Aya YAMADA KAMISAKA, Tokyo (JP); Hajime TOJIKI, Tokyo (JP); Kota HOSHIBA, Tokyo (JP); Ryota NAKANISHI, Tokyo (JP)

(73) Assignee: TOYOTA JIDOSHA KABUSHIKI KAISHA, Toyota-shi (JP)

(21) Appl. No.: 19/468,260

(22) Filed: Feb. 3, 2026

(30) Foreign Application Priority Data
Apr. 8, 2025 (JP) 2025-063780

(51) Int. Cl. G10L 15/08; G10L 15/18

(52) U.S. Cl. CPC G10L 15/083; G10L 15/1815

(57) ABSTRACT

Based on an utterance sentence of a user utterance, one or more external agents to which the utterance sentence is to be transmitted are decided from external agents each providing a dialogue service in natural language and specialized in one of a plurality of predetermined domains, the utterance sentence is transmitted to the external agents decided and one or more responses are acquired from the external agents and integrated, and an integrated response is provided to the user. Also, based on scores respectively set for the external agents, the external agents to which the utterance sentence is to be transmitted are decided, or based on the scores, which of the responses are to be objects of the integration is decided, and the scores corresponding to at least one of the one or more external agents are updated, based on behavior of the user following providing of the integrated response.

### CROSS-REFERENCE TO RELATED APPLICATION

This application claims priority to Japanese Patent Application No. 2025-063780 filed on Apr. 8, 2025. The disclosure of the above-identified application, including the specification, drawings, and claims, is incorporated by reference herein in its entirety.

### BACKGROUND

### 1. Technical Field

The present disclosure relates to dialogue technology.

### 2. Description of Related Art

There is technology for engaging in dialogue in natural language based on an input sentence. In this regard, for example, WO 2019/225201 discloses a device that is capable of engaging in dialogue with a plurality of agents via a network.

### SUMMARY

With future advances in machine learning, dialogue services in natural language are expected to become increasingly widespread.

An object of the present disclosure is to improve accuracy of dialogue using a machine learning model.

One aspect of the present disclosure is
an information processing device including a control unit that executes acquiring an utterance sentence based on an utterance made by a user, deciding, based on the utterance sentence, one or more external agents to which the utterance sentence is to be transmitted, from among a plurality of external agents each providing a dialogue service in natural language and each specialized in one of a plurality of predetermined domains, respectively, transmitting the utterance sentence to the one or more external agents that are decided upon, and acquiring one or more responses from the one or more external agents, and integrating the one or more responses and providing a response that is integrated to the user, in which the control unit decides, based on scores respectively set for the external agents, the one or more external agents to which the utterance sentence is to be transmitted, or decides, based on the scores, which of the one or more responses are to be objects of the integration, and updates the scores corresponding to at least one of the one or more external agents, based on behavior of the user following providing of the response that is integrated.

Also, other aspects include a program that causes a computer to execute a method executed by the above device, and a computer-readable storage medium that stores this program in a non-transitory manner.

According to the present disclosure, accuracy of dialogue using a machine learning model can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram of a dialogue system according to a first embodiment;

FIG. 1B is a schematic diagram of the dialogue system according to the first embodiment;

FIG. 1C is a schematic diagram of the dialogue system according to the first embodiment;

FIG. 2 is a hardware configuration diagram of an in-vehicle device 10;

FIG. 3 is a software configuration diagram of the in-vehicle device 10;

FIG. 4 shows an example of score data used by the in-vehicle device 10;

FIG. 5 is a diagram showing a flow of processing executed by the in-vehicle device in the first embodiment;

FIG. 6A is an example of text input to and output from an external agent;

FIG. 6B is an example of text input to and output from an external agent;

FIG. 6C is an example of text input to and output from an external agent;

FIG. 7A is an example of text input to and output from a local agent;

FIG. 7B is an example of text input to and output from the local agent;

FIG. 8 is a flowchart of processing executed by the in-vehicle device 10 in the first embodiment;

FIG. 9 is a diagram showing a flow of processing executed by the in-vehicle device 10 in a third embodiment;

FIG. 10 is a flowchart of processing executed by the in-vehicle device 10 in the third embodiment;

FIG. 11 is a diagram showing a flow of processing executed by the in-vehicle device 10 in a fourth embodiment; and

FIG. 12 is a flowchart of processing executed by the in-vehicle device 10 in the fourth embodiment.

### DETAILED DESCRIPTION OF EMBODIMENTS

In recent years, advances in machine learning have increased the number of products equipped with language models. For example, a dialogue function in natural-language can be added to a target product by incorporating into the product a large language model (LLM) of which accuracy has been improved through machine learning using a large-scale dataset.

A field in which dialogue in natural language is useful is automobiles. For example, equipping an in-vehicle device with an LLM enables information to be obtained without operating a touch panel or the like. Such a function is particularly useful when the hands of a user are occupied, such as while driving.

On the other hand, a trained LLM has a large data size, which is problematic in that it is difficult to install on embedded devices due to cost. Accordingly, instead of installing the LLM in equipment, a technique has been devised in which the LLM is accessed via a network. Accessing the LLM via a network enables the use of a large-scale language model that is difficult to install in local storage.

Also, going through a network enables selectively accessing LLMs that are specialized in a particular field. For example, when a plurality of LLMs is prepared, each field-specific, such as an LLM specialized in route guidance, an LLM specialized in regional information guidance, an LLM specialized in casual conversation, and so forth, the use of a network enables selection of an LLM of a usage that is relevant to intent of the user. In this regard, a technique is known in which a category of an utterance is determined based on content of the utterance of the user, and an LLM relevant to this category is automatically selected.

However, when an LLM is selected from among LLMs of multiple fields to engage in dialogue, there is an issue in that the dialogue may be limited to just the specific field in which the selected LLM is specialized.

For example, when an utterance of the user includes content such as “a warning light in the car turned on”, and an LLM specialized in vehicle operation guidance is selected, it is expected that information regarding the meaning of the warning light will be provided in response to the utterance. However, an LLM specialized in vehicle operation guidance does not have information about local regions, and therefore may be unable to provide a service that goes beyond the content of the utterance, such as “guiding the user to the nearest car dealership for inspection”.

One conceivable technique to address this issue is to transmit the content of the utterance (utterance sentence) of the user to multiple field-specific LLMs, and then integrate responses obtained therefrom and provide the integrated response to the user.

However, when an utterance sentence is transmitted unconditionally to multiple LLMs, another issue can arise in that a response from the LLMs may be provided that does not conform to the intention or request of the user.

An information processing device according to the present disclosure solves such issues.

An information processing device according to an aspect of the present disclosure includes a control unit that executes acquiring an utterance sentence based on an utterance made by a user, deciding, based on the utterance sentence, one or more external agents to which the utterance sentence is to be transmitted, from among a plurality of external agents each providing a dialogue service in natural language and each specialized in one of a plurality of predetermined domains, respectively, transmitting the utterance sentence to the one or more external agents that are decided upon, and acquiring one or more responses from the one or more external agents, and integrating the one or more responses and providing a response that is integrated to the user, in which the control unit decides, based on scores respectively set for the external agents, the one or more external agents to which the utterance sentence is to be transmitted, or decides, based on the scores, which of the one or more responses are to be objects of the integration, and updates the scores corresponding to at least one of the one or more external agents, based on behavior of the user following providing of the response that is integrated.

An external agent is a system that enables dialogue in natural language and that provides a dialogue service using language models each specialized in a corresponding one of multiple domains (fields). This language model may be a large language model (LLM). A large language model is, for example, a language model trained to be capable of executing dialogue tasks in natural language. Examples of the domains include “route guidance”, “regional information guidance”, “vehicle operation guidance”, “tourist guidance”, “casual conversation”, and so forth. These agents are typically configured to be remotely accessible via a network.

The control unit decides one or more external agents to which a content of an utterance made by a user (utterance sentence) is to be transmitted, transmits the utterance sentence to the external agents that are decided upon, and acquires responses therefrom. The control unit may transmit, via a network, a prompt text including the content of the utterance made by the user (utterance sentence) to the external agents that are decided upon. Thus, one or more responses can be acquired from the one or more external agents.

The control unit also integrates the one or more responses acquired from the external agents and provides the integrated response to the user. The integration of the responses may be performed using either a rule-based approach or another language model. For example, the integration of the responses may be performed by inputting the responses obtained from the external agents to an agent that operates locally and includes a language model (local agent).

The language model included in the local agent is a language model capable of executing dialogue tasks in natural language, but can be a language model that has not been trained to be specialized in any specific domain and is generated at a relatively low cost.

This configuration enables information to be acquired from multiple LLMs specialized in various fields, and to integrate such information and provide the integrated information to the user.

In the example described above, for example, integrating a response acquired from an LLM specialized in vehicle operation guidance with a response acquired from an LLM specialized in regional information guidance enables providing a message that both explains the meaning of the warning light and guides the user to a service location where the issue can be addressed.

On the other hand, when deciding upon an external agent to transmit an utterance sentence to, an external agent different from the intention of the user may be selected.

For example, when there are external agents belonging to domains such as “current affairs”, “economy”, “entertainment”, “sports”, “cooking”, and “show business”, and when there is an external agent that belongs to a domain that does not match the preferences of the user of the vehicle (e.g., “sports”), it is preferable not to actively select that external agent. Alternatively, even when that external agent is selected, it is preferable not to actively provide the user with a response therefrom.

Accordingly, the information processing device according to the present disclosure decides, by using scores set for respective external agents, one or more external agents to which the utterance sentence is to be transmitted. Alternatively, the information processing device decides, based on the scores, which of the one or more responses are to be integrated.

Further, the information processing device updates the score corresponding to at least one of the one or more external agents, based on behavior of the user after being provided with the integrated response.

The information processing device acquires the score set for each external agent, and uses the score to decide the external agent and to integrate responses.

The score may be set for each user. For example, with respect to a certain user, an LLM that the user wants to use preferentially may be given a higher score, and an LLM that the user wants to use less may be given a lower score. This enables suppressing transmission of utterance sentences to an LLM that does not match the preferences of the user, or excluding responses from that LLM from being integrated when integrating responses, for example.

The score is also updated based on the behavior of the user after providing a response. For example, when the user acts in accordance with content suggested by a certain LLM, the score of that LLM may be updated to be higher. Conversely, when the user ignores the content suggested by a certain LLM, the score of that LLM may be updated to be lower.

According to this configuration, information from an LLM that does not match the preferences of the user can be suppressed from being provided to the user.

The control unit may also further acquire feedback data indicating the behavior of the user after being provided with the integrated response, and update the score based on the feedback data.

The feedback data may include information about the behavior of the user, information indicating places to visit, information indicating uttered content, search history, information indicating gestures, and so forth.

For example, when the feedback data indicates that the user is positive about a response from a first external agent, the control unit may increase the score for the first external agent, and when the feedback data indicates that the user is negative about a response from the first external agent, the control unit may decrease the score for the first external agent.

Hereinafter, embodiments of the present disclosure will be described with reference to the drawings. The hardware configuration, module configuration, functional configuration, and so forth, described in each embodiment are not intended to limit the technical scope of the disclosure to these configurations alone, unless otherwise specified.

### First Embodiment

### System Overview

An overview of a dialogue system according to a first embodiment will be described. The dialogue system according to the present embodiment is configured including an in-vehicle device 10 installed in a vehicle. The in-vehicle device 10 can access, via a network (e.g., mobile communication network), agents (external agents) that provide dialogue services in natural language.

The in-vehicle device 10 is installed in a connected vehicle that can communicate with various devices via wireless communication. The in-vehicle device 10 may include a data communication module (DCM) for connecting components of the vehicle (e.g., an electronic control unit (ECU), an in-vehicle terminal, etc.) to a network. In the present embodiment, the in-vehicle device 10 can access the Internet via a mobile communication network that is set in advance, and connect to agents and so forth that provide dialogue services.

The vehicle (or components installed in the vehicle) can also provide various services by communicating with external devices via the in-vehicle device 10. Examples of such services include navigation services, remote control services (e.g., remote air conditioning, etc.), in-vehicle Wi-Fi (registered trademark) services, emergency call services, and so forth.

The in-vehicle device 10 further has a speech input and output function, and is capable of engaging in dialogue in natural language with occupants of the vehicle.

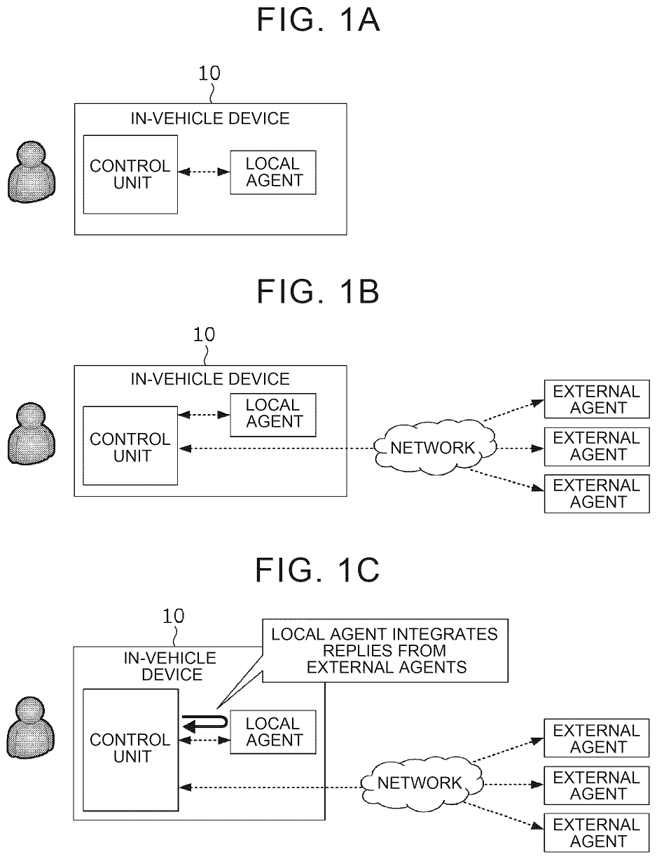

FIG. 1A is a schematic diagram illustrating the in-vehicle device 10 with a conventional configuration.

The in-vehicle device 10 that is illustrated is configured including a control unit to perform audio input and output and speech recognition, and a local agent. The local agent includes a language model that is trained to enable dialogue in natural language. For example, the local agent may provide a predetermined function such as route search, vehicle operations (air conditioning, etc.), or the like, through dialogue. In the form that is illustrated, the language model used by the local agent is stored in a storage device included in the in-vehicle device 10.

On the other hand, providing a dialogue service using a large-scale language model in such a form is difficult. For example, there is a wide variety of dialogue categories, including regional information, tourist guidance, vehicle-related information (operation manuals), casual conversation, and so forth, and in order to cover all of these categories, preparing a language model trained using large-scale training data is necessary. Such language models may range in size from several gigabytes to several hundred gigabytes, and storage thereof in local storage is not realistic from a cost perspective.

Accordingly, systems have been proposed in which a language model specialized in dialogue in a specific domain is accessed via a network.

FIG. 1B is a schematic diagram of a form in which the in-vehicle device 10 can access not only the local agent, but also a plurality of language models provided on the Internet. For example, a form is conceivable in which multiple agents (external agents), each having a large language model specialized in a specific domain, are deployed on devices connected to the Internet, and the in-vehicle device 10 accesses a language model selected in accordance with a request.

However, in this form, there is an issue in that dialogue is limited to just a specific field (domain). For example, when the user wishes to obtain information about a particular sport, it is expected that the user will engage in dialogue with an agent specialized in that sport. However, this agent cannot provide information other than information related to the sport, such as venue information or the like, and accordingly, this agent is unable to take care of the user by, for example, guiding the user to a venue where the user can watch the sport.

Accordingly, in the in-vehicle device 10 of the present embodiment, the local agent is provided with a function to integrate responses from multiple external agents. The content of the utterance of the user (utterance sentence) is transmitted to multiple external agents, and responses are acquired from these external agents. These responses are integrated at the local agent, and the integrated response is provided to the user. FIG. 1C is a schematic diagram of the in-vehicle device 10 according to the present embodiment.

Upon recognizing the utterance of the user, the in-vehicle device 10 decides, based on the content of the utterance, “which of the external agents are suitable for this utterance”. This processing may be performed using either a rule-based approach or a machine learning model. The control unit also transmits the utterance sentence to the one or more external agents that are decided upon.

Responses from the external agents that are selected are integrated by the local agent, and the integrated response is provided to the user.

This enables appropriately providing responses obtained from multiple external agents to the user.

On the other hand, in a form in which multiple responses from multiple external agents are integrated, a new issue can arise in that information not desired by the user is intermingled into the integrated response. For example, as a result of selecting external agents to be used based on the content of the utterance, a situation can occur in which an external agent belonging to a domain that does not match the preferences of the user is selected.

To address this, in the present embodiment, the in-vehicle device 10 sets, for each user, scores for the external agents and controls information collection based on the scores that are set. Thus, handling by “not using external agents belonging to domains in which the user has no interest”, for example, can be realized.

Note that in the description of the present embodiment, expressions such as “access to an external agent” and “connect to an external agent” refer to accessing or connecting to an external device that provides a dialogue service via the external agent. In the present embodiment, each of a plurality of the dialogue services using large language models is running as an “external agent” on a corresponding one of a plurality of external devices, and the in-vehicle device 10 can engage in dialogue by connecting to any of these external agents.

### Hardware Configuration

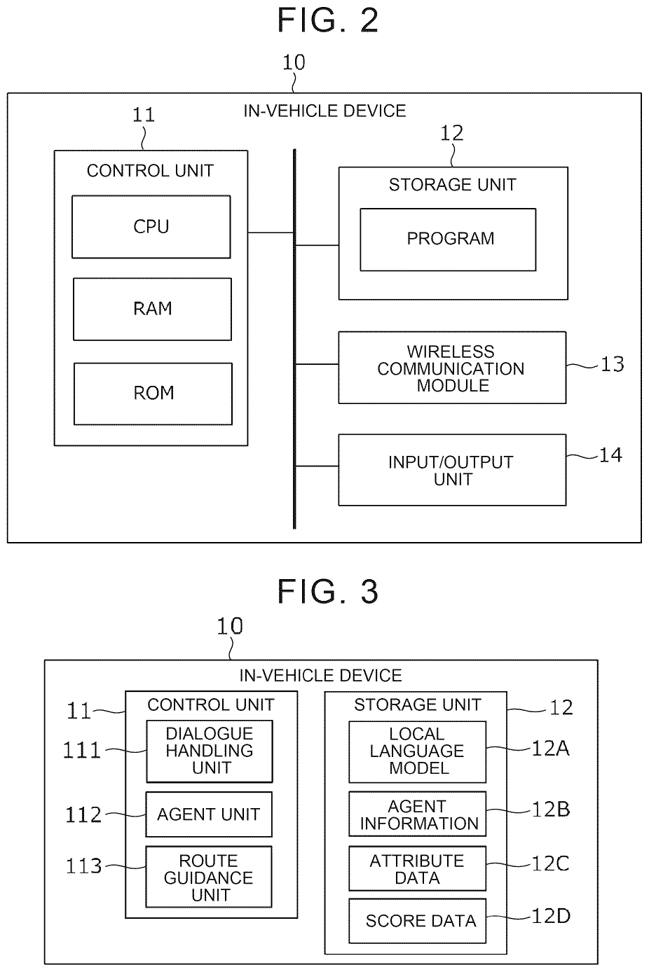

Next, the hardware configuration of the devices making up the system will be described. FIG. 2 is a diagram schematically illustrating an example of the hardware configuration of the in-vehicle device 10 according to the present embodiment.

The in-vehicle device 10 can be configured as a computer that includes a processor (a central processing unit (CPU), a graphics processing unit (GPU), etc.), a main storage device (random access memory (RAM), read-only memory (ROM), etc.), and an auxiliary storage device (erasable programmable read-only memory (EPROM), hard disk drive, removable medium, etc.). The auxiliary storage device stores an operating system (OS), various types of programs, various types of tables, and so forth, and various types of functions (software modules) for predetermined purposes, as described later, can be realized by executing the programs stored therein. Note, however, that part or all of the functions may be alternatively realized as hardware modules by using hardware circuits such as application-specific integrated circuits (ASICs) field-programmable gate arrays (FPGAs), and so forth, for example.

The in-vehicle device 10 is configured including, as hardware components, a control unit 11, a storage unit 12, a wireless communication module 13, and an input/output unit 14.

The control unit 11 is a computing unit that realizes various types of functions of the in-vehicle device 10 by executing predetermined programs. The control unit 11 can be realized by, for example, a hardware processor such as a CPU or the like. The control unit 11 may also be configured including RAM, ROM, cache memory, and so forth.

The storage unit 12 is means for storing information, and is made up of a storage medium such as RAM, a magnetic disk, flash memory, or the like. The storage unit 12 stores programs executed by the control unit 11, and data and so forth used by these programs.

The wireless communication module 13 is a communication device that performs wireless communication with a predetermined network. In the present embodiment, the wireless communication module 13 is configured to be communicable with a predetermined mobile communication network. The wireless communication module 13 can be configured including an embedded Universal Integrated Circuit Card (eUICC) (e.g., a Subscriber Identity Module (SIM) card). The SIM card is configured as a microcomputer that includes a CPU and a storage device. The SIM card stores information for connecting to a mobile communication network and receiving authentication.

The input/output unit 14 is a unit that accepts input from a user of the device and presents information to the user. The input/output unit 14 typically is configured including devices to input and output audio, such as a microphone and a speaker. The input/output unit 14 may also include a device that provides visual information (display, etc.).

### Software Configuration

Next, the software configuration of the devices making up the system will be described. FIG. 3 is a diagram schematically illustrating the software configuration of the in-vehicle device 10 according to the present embodiment.

In the present embodiment, the control unit 11 of the in-vehicle device 10 is configured including three software modules, which are a dialogue handling unit 111, an agent unit 112, and a route guidance unit 113. Each of the software modules may be realized by executing a program stored in the storage unit 12 using the control unit 11 (CPU, etc.). Note that the information processing executed by the software modules is synonymous with the information processing executed by the control unit 11 (CPU, etc.).

The dialogue handling unit 111 acquires an utterance made by a vehicle occupant (hereinafter also referred to as “user”) via the input/output unit 14. The dialogue handling unit 111 executes predetermined processing on voice data that is acquired, and executes speech recognition. Content of the utterance is thus converted into text. The dialogue handling unit 111 also transmits the text obtained as a result of the speech recognition to the agent unit 112.

Also, the dialogue handling unit 111 outputs a response (hereinafter referred to as “reply sentence”) from the language model transmitted by the agent unit 112. The dialogue handling unit 111 converts the reply sentence into speech, and performs output thereof via the input/output unit 14.

The agent unit 112 firstly provides a dialogue service using a language model stored in the own device (local language model 12A, described later). The agent unit 112 can behave as a virtual agent (local agent). The local agent can provide, for example, a dialogue service that can be completed within the own device (e.g., casual conversations, etc.).

Also, when the dialogue requires specialized knowledge, the agent unit 112 transmits the utterance sentence to one or more external agents that are available via the network, and acquires results thereof. For example, when determination is made that the user is seeking information regarding the vehicle, the agent unit 112 selects an external agent capable of providing vehicle operation guidance. Also, when determination is made that the user is seeking information regarding facilities or shops, the agent unit 112 selects an external agent that is capable of providing regional information.

The selection of the external agent may be based on results of analyzing the content of the utterance. For example, the agent unit 112 may calculate a relevance for each of the external agents based on words included in the utterance sentence or context thereof, and transmit the utterance sentence to an external agent of which the relevance that is obtained is a predetermined value or higher.

The agent unit 112 may also select multiple external agents to which the utterance sentence is to be transmitted. For example, when there are multiple external agents of which the relevance regarding the utterance sentence is the predetermined value or higher, the agent unit 112 may transmit the utterance sentence to these external agents. In this case, the agent unit 112 acquires reply sentences to the utterance sentence obtained from these external agents, integrates these responses, and provides an integrated response to the user.

Further, when selecting external agents, the agent unit 112 uses score data that is set in advance for each user. The score data is data that represents a precedence for each of the external agents.

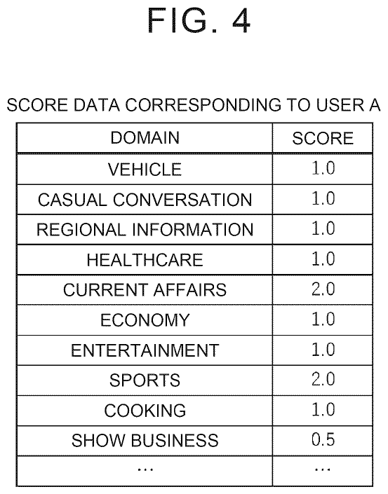

FIG. 4 shows an example of score data. In the present embodiment, the score data is compiled as combinations of domains of the external agents and scores. The score is a numerical representation of the degree of interest or preference of the user. The example shown here in the drawing indicates that user A has a strong interests in current affairs and sports, but has little interest in show business.

In the present embodiment, the agent unit 112 excludes external agents corresponding to domains of which scores are below a predetermined value from candidates for selection. That is to say, utterance sentences will not be transmitted to external agents with domains of which the scores are lower the predetermined value (e.g., 1.0).

This can suppress situations in which the user is presented with responses regarding fields in which they have little interest.

Description will be continued, returning to FIG. 3.

The route guidance unit 113 accepts a departure point and a destination specified by the user, and generates a route connecting the departure point and the destination based on road map data and so forth. Information relating to the route that is generated is also output thereby, via the input/output unit 14.

The storage unit 12 of the in-vehicle device 10 stores the local language model 12A, agent information 12B, attribute data 12C, and score data 12D.

The local language model 12A is a language model that is trained to be capable of executing dialogue tasks in natural language. The local language model 12A is a language model that is generated at relatively low cost and is not trained to engage in dialogue specialized in specific domains. It is sufficient for the local language model 12A to be a language model for engaging in general conversations. For example, a language model that is publicly available as open-source may be used as the local language model 12A.

The local language model 12A is a lightweight language model as compared to the large language models that the external agents accessible via network have. The use of the local language model 12A by the agent unit 112 enables dialogue with lively responses. This enables differentiation in way of use, such as for example, when specialized conversation is required, utterance sentences can be transmitted to an external agent, while when conversations require a quick response, the local agent can perform processing of the utterance sentences.

The agent information 12B is a set of data regarding the multiple external agents available to the in-vehicle device 10. The agent information 12B may include, for example, identifiers and names of the external agents, information regarding the specialized domains, information regarding access destinations (e.g., network addresses of external devices that provide the external agents, etc.), and so forth. The agent unit 112 can reference the agent information 12B to decide the external agent to which the utterance sentence is to be transmitted.

The attribute data 12C is a set of data relating to attributes of the user who engages in dialogue with the in-vehicle device 10. The attribute data 12C may include, for example, personal information such as gender, age, height, and weight, and so forth, of the user. Also, when there is a plurality of users of the vehicle, the attribute data 12C may also include data for each of the multiple users.

As described with reference to FIG. 4, the score data 12D is data representing the degree to which the domains, in which the respective external agents are specialized, are relevant to the user who is the object. The score data 12D is defined for each of multiple users who might ride in the vehicle.

### Flow of Dialogue

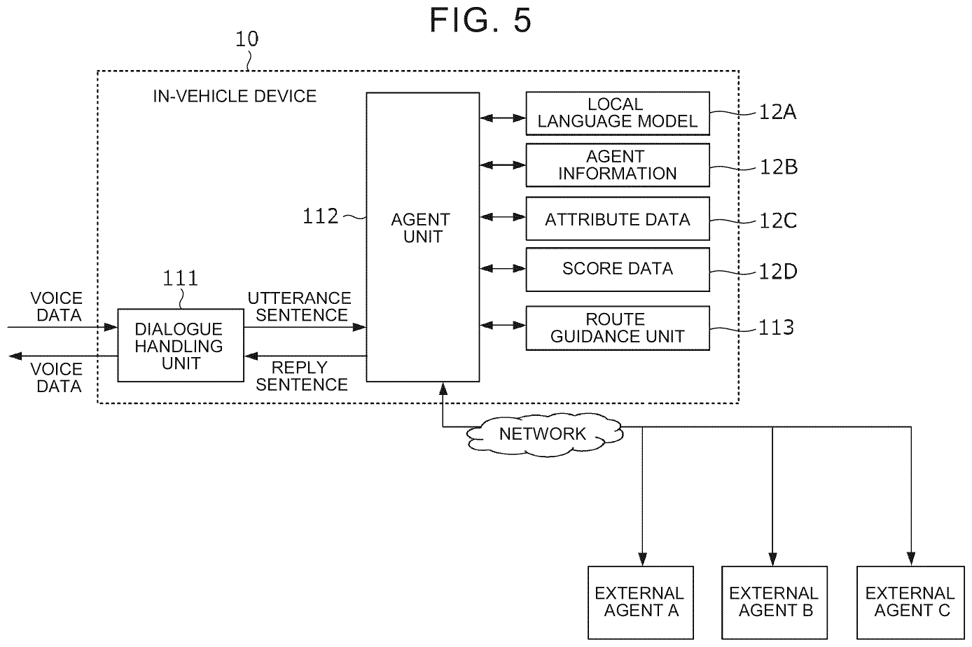

Next, an overview of the processing executed by the control unit 11 will be described. FIG. 5 shows a flow of processing executed by the control unit 11 of the in-vehicle device 10 after receiving an utterance from the user.

The dialogue handling unit 111 acquires an utterance from the user via the input/output unit 14. For example, the input/output unit 14 converts the utterance acquired through a microphone or the like into voice data, and the dialogue handling unit 111 acquires the voice data. The dialogue handling unit 111 executes predetermined speech recognition processing on the voice data that is acquired and converts the voice data into text. While a response to the utterance on hold, the dialogue handling unit 111 transmits the text obtained as a result of the speech recognition to the agent unit 112. This text is referred to as “utterance sentence”.

Upon receiving the utterance sentence, the agent unit 112 determines intent of the utterance (what the user is requesting) and the situation of the user (what the user is currently doing), based on the content of the utterance, and decides an external agent to which the utterance sentence is to be transmitted. The intent of the utterance may be determined using the local language model 12A, or may be determined using another machine learning model. This intent of the utterance may alternatively be determined using a rule-based approach.

Also, the situation of the user may be determined using sensor data in addition to the utterance. For example, the agent unit 112 may use data acquired from sensors installed in the vehicle, such as vehicle speed, current position, direction of travel, and so forth, in addition to the utterance to determine the situation of the user. Examples of the situation of the user include “traveling on a non-freeway road”, “traveling on a freeway”, “temporarily stopped”, “waiting at a traffic light”, “commuting to work”, “returning home”, and so forth.

The agent unit 112 acquires information regarding the external agents (agent information 12B) from the storage unit 12, and decides on an external agent to which the utterance sentence is to be transmitted, based on the agent information 12B, and the intent and the situation that are determined. For example, the agent unit 112 may calculate a relevance for each of the multiple external agents, and decide to transmit the utterance sentence to an external agent of which the relevance that is obtained is the predetermined value or higher.

In this example, the following three external agents are exemplified.
(1) Vehicle agent

An external agent capable of comprehending the situation in the vehicle, and setting in-vehicle equipment. This external agent has been trained on a vehicle owner's manual, and is also capable of providing information regarding the functions of the vehicle.
(2) Casual conversation agent

An external agent specialized in non-task-oriented chatting.
(3) Regional information agent

An external agent capable of providing nearby regional information including shop guidance and tourist guidance.

Also, it is presumed in this example that the vehicle agent and the regional information agent have been selected as the external agents relevant to the utterance.

Note that there are cases in which the agent unit 112 determines that there is no need to transmit the utterance sentence to any external agent. This applies to, for example, cases in which the request of the user can be handled entirely within the own device, such as when the request of the user involves route guidance or the like, cases in which a quick response is demanded, or the like. In such cases, processing of the utterance sentence is performed by the agent unit 112 (and local language model 12A) alone.

Next, the agent unit 112 filters the external agents that are selected, based on the preferences of the user. The agent unit 112 excludes external agents of domains, of which scores are below a predetermined value, from selection candidates, based on the score data 12D.

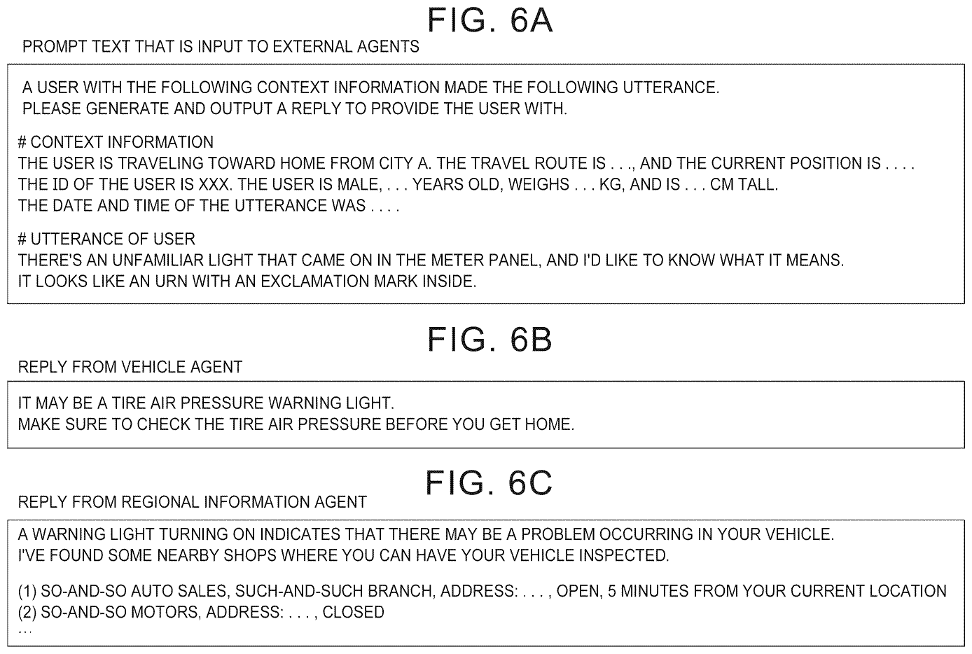

The agent unit 112 then generates a prompt text to be input to the external agents that are selected. FIG. 6A shows an example of the prompt text input from the agent unit 112 to the external agents.

The prompt text includes not only the utterance sentence but also context information corresponding to the user.

In the present embodiment, context information is information that accompanies the utterance sentence and includes attribute information of the user and information regarding movements of this user. The context information may include personal information such as, for example, gender, age, height, weight, and so forth, of the user. Such information may be acquired from the attribute data 12C stored in the storage unit 12.

The context information may also include information regarding movements of the user. Examples of such information include information regarding the departure point, destination, travel route, waypoints, and so forth, of the vehicle. Such information may be acquired from the route guidance unit 113.

The external agents can generate responses based further on this context information.

The agent unit 112 transmits the prompt text that is generated via the network to the external devices that provide the intended external agents.

Each external agent to which the utterance sentence is input outputs a response to this utterance sentence. FIG. 6B shows an example of a response from the vehicle agent, and FIG. 6C shows an example of a response from the regional information agent. As shown in these drawings, each agent outputs a response related to the domain in which it is specialized. For example, the vehicle agent outputs information regarding the specific meaning of the warning light, and the regional information agent outputs information regarding spots where the vehicle can be inspected.

Upon receiving responses from the external agents to which the utterance sentence was transmitted, the agent unit 112 integrates those responses. The integration of the responses can be performed using the local language model 12A.

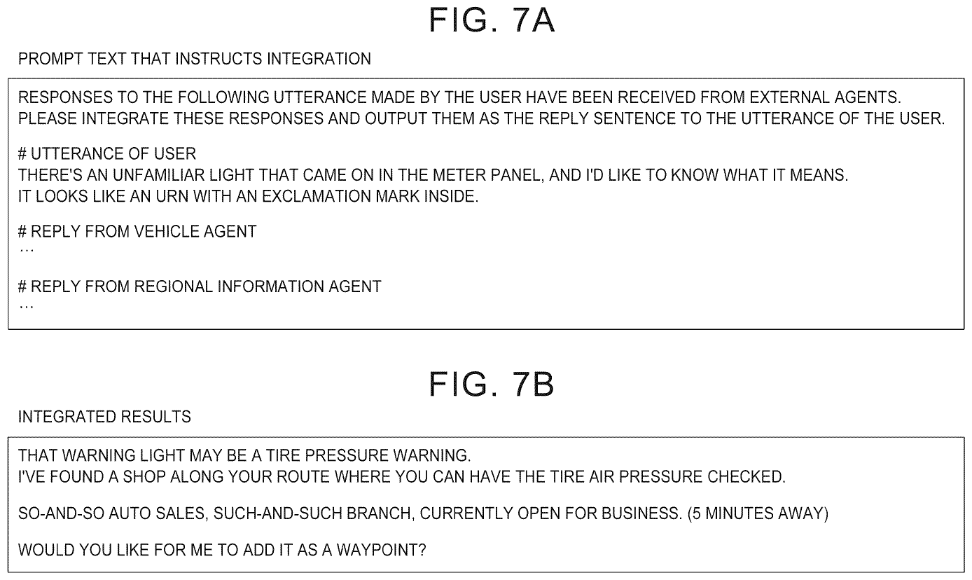

For example, the agent unit 112 inputs a prompt text, including one or more responses that are received, to the local language model 12A so as to integrate the responses. This prompt text includes, for example, the utterance made by the user, the responses obtained from the multiple external agents, and an instruction to integrate the contents of the responses and generate a new text. FIG. 7A is an example of a prompt text that is input to the local language model 12A.

As a result, a reply sentence that is integrated is output from the local language model 12A. FIG. 7B shows an example of a reply sentence obtained as a result of the integration. The reply sentence that is integrated is then transmitted from the agent unit 112 to the dialogue handling unit 111.

Upon receiving the reply sentence, the dialogue handling unit 111 generates speech data based on this reply sentence, and outputs the speech data via the input/output unit 14. Note that the dialogue handling unit 111 may generate just the speech data for reading out the reply sentence, or may additionally generate information accompanying the speech data. Examples of the information accompanying the speech data include a user interface screen. This user interface screen may include the reply sentence in written form.

The dialogue system according to the present embodiment seamlessly performs a series of processing that is shown in FIG. 5. This can yield an effect in which the user who made the utterance is under an impression that they are engaging in dialogue with the in-vehicle device 10.

### Flowchart

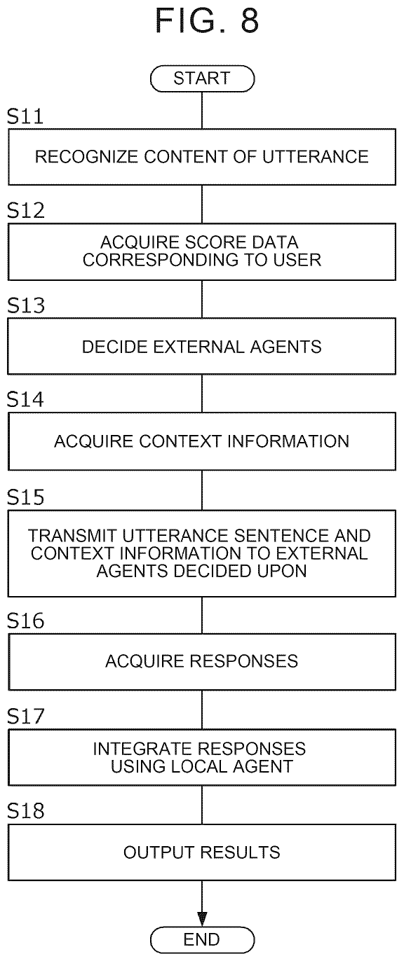

Next, the processing executed by the in-vehicle device 10 will be described in detail. FIG. 8 is a flowchart of the processing executed by the in-vehicle device 10. The processing shown in FIG. 8 starts when an utterance made by the user (occupant of vehicle) is detected. The start of the utterance may be detected by, for example, a predetermined keyword.

First, in step S11, the dialogue handling unit 111 recognizes the content of the utterance. The dialogue handling unit 111 acquires voice data output from the input/output unit 14 and executes speech recognition processing on the voice data to convert the utterance into text. The text following conversion (utterance sentence) is transmitted to the agent unit 112.

Next, in step S12, the agent unit 112 acquires score data corresponding to the user who made the utterance. The user who made the utterance may be identified based on voice, or in a case in which the vehicle is equipped with a personal authentication device (e.g., facial authentication device or fingerprint authentication device), may be identified based on an authentication result thereby.

In step S13, the agent unit 112 decides external agents to which the utterance sentence is to be transmitted. The external agents to which the utterance sentence is to be transmitted may be decided by, for example, estimating the intent of the user (what the user is requesting) or situation (what the user is currently doing), from the utterance sentence, and making the decision based on the result thereof.

For example, the agent unit 112 may read information regarding features of the external agents (agent information 12B) from the storage unit 12 and decide which external agents to use, based on this information.

Also, as described above, the agent unit 112 filters the external agents to which the utterance sentence is to be transmitted, based on the score data. The agent unit 112 excludes external agents for domains of which scores are below the predetermined value, from being selection candidates, based on the score data 12D.

Next, in step S14, the agent unit 112 acquires context information of the user. When the context information is information regarding movements of the user, this information may be acquired from the route guidance unit 113. Also, when the context information is attribute information of the user, this information (attribute data 12C) may be acquired from the storage unit 12.

In step S15, the agent unit 112 transmits the utterance sentence and the context information to the external agents decided in step S13. For example, the agent unit 112 accesses, via the wireless communication module 13, external devices providing services of the relevant external agents, and transmits the utterance sentence and the context information to these external agents.

In step S16, the agent unit 112 acquires responses corresponding to the utterance sentence from the relevant external agents.

In step S17, the agent unit 112 integrates these responses using the local language model 12A. Specifically, the agent unit 112 generates a prompt text that includes a list of responses acquired from the multiple external agents, and an instruction to integrate these responses, and inputs this prompt text to the local language model 12A. The reply sentence following integration, that is output from the local language model 12A, is then acquired thereby.

In step S18, the agent unit 112 transmits the reply sentence obtained as the result of the integration to the dialogue handling unit 111. The dialogue handling unit 111 generates audio data based on the reply sentence and outputs the audio data via the input/output unit 14. The dialogue handling unit 111 may convert the reply sentence into speech data, using speech synthesis technology. The speech data is output via the input/output unit 14 (speaker, etc.) and provided to the user.

As described above, in the in-vehicle device 10 according to the present embodiment, the local agent decides to which external agents the content of the utterance made by the vehicle occupant is to be transmitted. The local agent also integrates the reply sentences obtained from the external agents and outputs the reply sentence that is integrated. This enables collectively providing the content of responses, obtained from multiple external agents that handle highly specialized topics, to the user.

Further, the external agents to which the utterance sentence is to be transmitted are filtered using the preferences of the individual user, and accordingly responses regarding fields that are not of interest to that user can be excluded.

### Second Embodiment

In the first embodiment, description was made that when external agents are selected in step S13, external agents that are not suitable for the user are excluded using the score data. However, an arrangement may also be made in which the utterance sentence is transmitted to the external agents without taking into consideration the preferences of the user, and at the time of integrating the responses, exclude responses that are not suitable for this user.

In a second embodiment, filtering of external agents using the score data is not executed in step S13. That is to say, in the second embodiment, the utterance sentence is transmitted to the external agents without filtering in accordance with the preferences of the user.

On the other hand, in the second embodiment, filtering of information is executed at the timing of integrating the responses in step S17. Specifically, responses from external agents of domains of which scores are below the predetermined value are excluded from the objects of integration. In this configuration as well, the objective of “providing responses excluding responses about fields that are not of interest to the user” can be achieved.

### Third Embodiment

In the first and second embodiments, description was made that external agents to be used are selected using score data generated in advance. On the other hand, the score data may be updated as appropriate. A third embodiment is an embodiment in which the score data is updated based on feedback from the user.

In the third embodiment, the agent unit 112 is configured to be capable of acquiring data related to behavior of the user, after the reply sentence is provided to the user (hereinafter, feedback data). Examples of behavior of the user include utterances, movements, and so forth. The feedback data may include, for example, content of utterances of the user, analysis results of the utterances, history of movements (e.g., where the user went after acquiring the reply sentence), and so forth.

For example, when the user who received the reply sentence makes a positive statement immediately thereafter, it is conceivable that this user has a positive impression of at least one or more of the domains to which the external agents that were used belong. Also, when the user who received the reply sentence behaves in accordance with the reply sentence (e.g., a case of actually visiting a spot recommended by an external agent, or the like), it is conceivable that this user has a positive impression of at least one or more of the domains to which the external agents that were used belong.

In this case, it is preferable to raise the score included in the score data for the domain to which the corresponding external agent belongs.

In the third embodiment, the score data is updated in this way, based on such feedback from the user after the reply sentence is provided.

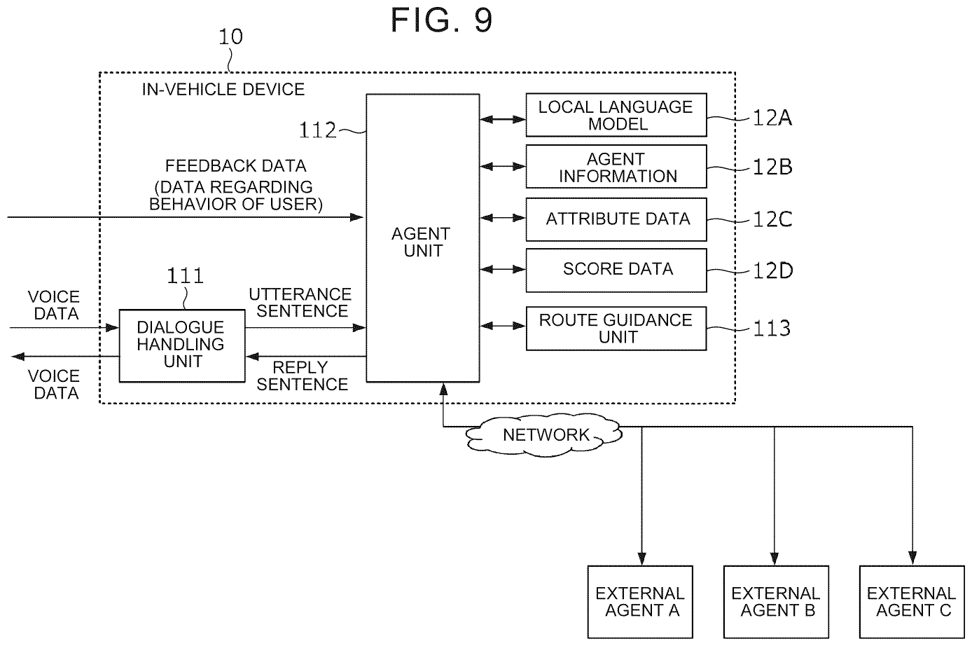

FIG. 9 shows a flow of processing executed by the control unit 11 of the in-vehicle device 10 upon receiving an utterance from the user in the third embodiment. As shown in this drawing, in the third embodiment, the agent unit 112 is configured to be capable of acquiring feedback data.

The feedback data may be text representing an utterance made by the user after the reply sentence has been provided, or may be analysis results of that utterance (e.g., a numerical value indicating the degree of positivity, etc.). The feedback data may also be data indicating reactions of the user after the reply sentence has been provided. For example, the feedback data may be data indicating the content of gestures performed by the user (nodding, shaking the head, etc.). The feedback data may also be data related to the behavior of the user after the reply sentence has been provided (e.g., transition in position information, identifiers of visited spots, etc.).

The agent unit 112 also evaluates each external agent, based on the feedback data, and updates the score data.

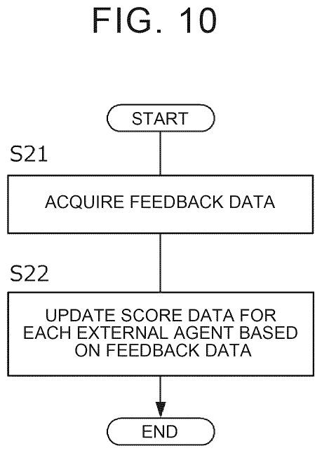

FIG. 10 is a flowchart of processing executed by the agent unit 112 according to the third embodiment. The processing illustrated here is executed following step S18 (processing of outputting the reply sentence that is integrated).

First, in step S21, the agent unit 112 acquires feedback data indicating the content of feedback from the user. When the feedback is given by speech, the agent unit 112 acquires the utterance of the user and obtains analysis results of the utterance of the user as feedback data. When the feedback is given by behavior of the user, the agent unit 112 acquires data about behavior of the user, and acquires analysis results of the behavior of the user as feedback data. Feedback may be detected through actions of the user other than these, as a matter of course.

Then, in step S22, the agent unit 112 updates the score data for each external agent based on the feedback data.

For example, when an external agent suggests a visit to a particular spot, and confirmation is made, based on the feedback data, that the suggested spot was actually visited, the agent unit 112 performs processing for raising the score for the domain to which that external agent belongs.

Also, when the feedback data indicates that the user reacted positively to the content output by a particular external agent, the agent unit 112 performs processing of raising the score for the domain to which that external agent belongs. Examples of positive reactions include positive statements, positive reactions, and so forth.

Note that when the feedback data indicates that the user reacted negatively to the content output by a particular external agent, the agent unit 112 may perform processing to lower the score for the domain to which that external agent belongs. Examples of negative reactions include negative statements, negative reactions, and so forth.

Note that the agent unit 112 may perform processing to determine which of the external agents that the feedback performed by the user is directed to. For example, when the content of the feedback is moving to a certain spot, it can be understood that the external agent that suggested a visit to that spot is the object of evaluation.

Also, for example, when the content of the feedback is an utterance made by the user, which external agent the feedback is directed to may be determined by analyzing the content of the utterance. For example, when an external agent belonging to the domain “show business” provides show business news and the user makes an utterance indicating that they are not interested in show business, it can be understood that the external agent belonging to the domain “show business” is the object of evaluation.

Note that when it is unclear which of the multiple external agents is the object of the feedback, the agent unit 112 may ask the user a further question.

For example, when a suggestion to watch a baseball game is made as a result of integrating responses from an external agent belonging to a domain “sports” and an external agent belonging to a domain “baseball”, and a negative utterance is made in response, it is not possible to determine whether the user has no interest in baseball, or has no interest in sports in general. Accordingly, the agent unit 112 may ask the user a further question to identify which external agent is the object of the feedback.

Furthermore, the agent unit 112 may be configured to acquire feedback regarding external agents directly from the user. For example, the agent unit 112 may present the user with a list of external agents used, and have the user input an evaluation score for each. In this case, the feedback data includes the evaluation scores imparted by the user.

Note that the agent unit 112 may update the score data each time of detecting positive or negative feedback from the user, or may accumulate feedback data and update the score data at a predetermined timing based on the feedback data that is accumulated. In this case, more recent feedback data may be weighted with a greater weighting.

As described above, in the third embodiment, the score data can be appropriately updated, based on feedback from the user.

### Fourth Embodiment

In the future, it is expected that many external agents that are provided by third parties will come on the scene. In such cases, rather than just processing the feedback from the user locally, it is preferable to share the feedback from the user among a plurality of vehicles, so as to be used for evaluating the external agents.

A fourth embodiment is an embodiment in which an agent that evaluates external agents (hereinafter, “evaluation agent”) is deployed, and the evaluation agent rates external agents based on feedback data transmitted from a plurality of the in-vehicle devices 10.

In the fourth embodiment, each of the in-vehicle devices 10 receives rating results from the evaluation agent, and updates the score data 12D based thereupon.

Note that while the feedback data in the third embodiment reflects individual preferences, the feedback data in the fourth embodiment is used to evaluate performance and reliability of external agents, such as accuracy of information, appropriateness of timing of providing information, and so forth. Accordingly, in the fourth embodiment, evaluation scores imparted by users to the respective external agents are used as feedback data, rather than behavior of the users. The score data is defined for each of the external agents, rather than for each of the domains.

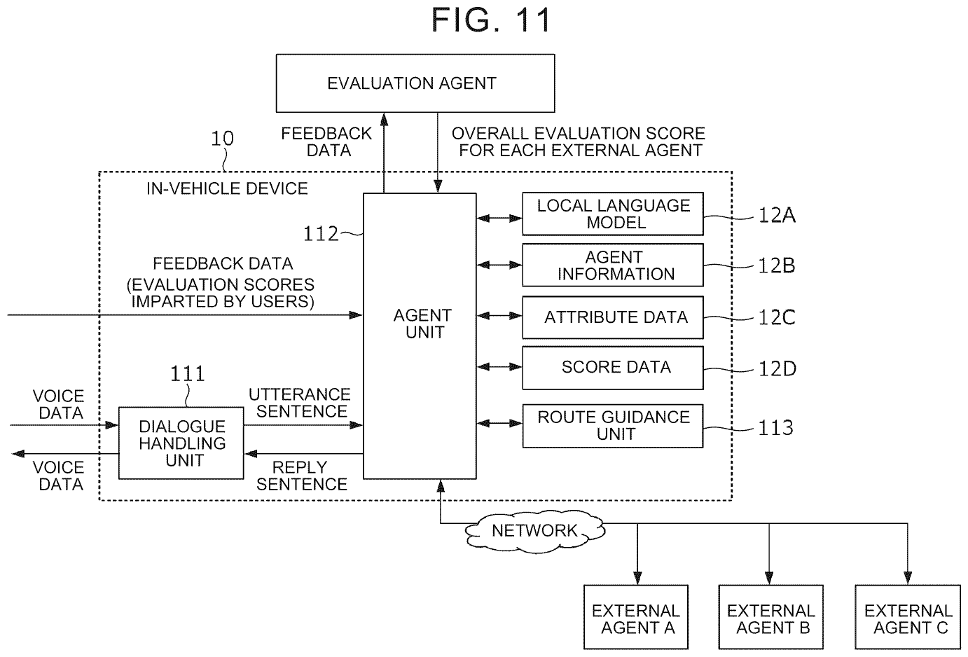

FIG. 11 shows a flow of processing executed by the control unit 11 of the in-vehicle device 10 upon receiving an utterance from a user in the fourth embodiment. As shown in this drawing, in the fourth embodiment, the agent unit 112 transmits the feedback data that is acquired to the evaluation agent. As described above, the feedback data in the present embodiment includes evaluation scores for the external agents that are used. Accordingly, the agent unit 112 may present the user with a list of external agents used, and have the user input evaluation scores.

The agent unit 112 associates the feedback data with the relevant external agents, and performs transmission thereof to the evaluation server. When there are multiple external agents to be evaluated, a plurality of pieces of feedback data is transmitted as well.

The feedback data that is transmitted is tabulated by the evaluation server. The evaluation server tabulates the evaluation scores included in the feedback data acquired from the multiple in-vehicle devices 10 and calculates an overall evaluation score for each external agent. The overall evaluation score may be calculated taking into account degree of influence of each user. The calculated overall evaluation scores are provided in accordance with requests from the in-vehicle devices 10.

The agent unit 112 also updates the score data 12D based on the overall evaluation scores for each of the external agents, provided from the evaluation server. Acquisition of the overall evaluation scores from the evaluation server and updating of the score data may be performed at a predetermined cycle, or may be performed following the processing of transmitting feedback data to the evaluation server.

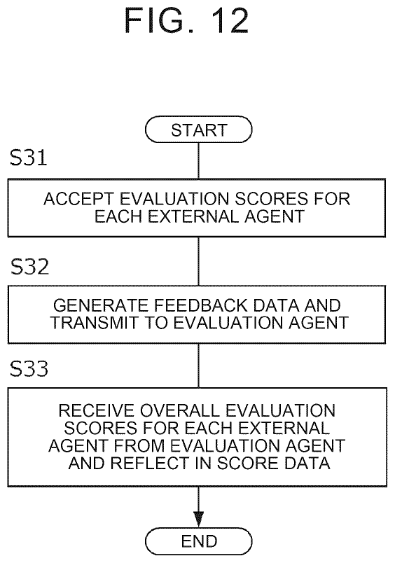

FIG. 12 is a flowchart of processing executed by the agent unit 112 in the fourth embodiment. The processing shown in the drawing is executed following step S18 (processing of providing reply sentence), in the same way as in FIG. 10.

First, in step S31, the agent unit 112 accepts, from the user, input of evaluation scores for each of the external agents used.

Next, in step S32, the agent unit 112 generates the feedback data including the evaluation scores and transmits the feedback data to the evaluation agent. When there are multiple target external agents, multiple pieces of feedback data are generated.

Next, in step S33, the agent unit 112 receives, from the evaluation agent, the overall evaluation scores for each of the external agents, and performs reflecting thereof in the score data 12D stored in the own device. In this step, for example, a lower score may be given to an external agent having a lower overall evaluation score, and a higher score may be given to an external agent having a higher overall evaluation score.

In the present embodiment, the content of evaluations made by other users can be reflected in the score data 12D. With such a configuration, advantageous effects can be yielded, in that external agents that receive higher evaluations from multiple users will be used more actively, whereas external agents that receive lower evaluations will be used less actively.

Note that while FIG. 4 shows an example in which a single type of score is defined in the score data 12D, the scores included in the score data may include both scores reflecting individual preferences and scores reflecting information from the evaluation agent. Also, the agent unit 112 may use these scores in an integrated manner.

### Modifications

The above-described embodiments are merely examples, and the present disclosure may be implemented modified as appropriate, without departing from the scope thereof.

For example, the processing and means described in the present disclosure can be implemented freely combined insofar as no technical contradiction occurs.

Also, the embodiments exemplify the forms in which external agents are deployed on external devices connected to the Internet, but the external agents may be deployed on other types of devices instead. For example, the external agents may be deployed on an edge server that is accessible from the vehicle. Also, the external agents may be deployed distributed across a plurality of edge servers, or in the cloud.

Also, the embodiments exemplify an in-vehicle device, but the information processing device according to the present disclosure can be implemented as a device or as equipment that is not installed in a vehicle.

Note that when the external agents are deployed across multiple edge servers or the like, the in-vehicle device 10 may acquire position information of the own vehicle and identify, based on the position information, the edge server on which an intended external agent is deployed. For example, there may be cases in which external agents that provide regional information are each deployed on respective edge servers disposed in respective regions. In such a case, the in-vehicle device 10 may identify the external agent deployed on the geographically closest edge server, based on the position information of the vehicle, for example. The regional information handled by the external agents may differ from one edge server to another. For example, an external agent that provides regional information for area A may be deployed on an edge server disposed in area A, and an external agent that provides regional information for area B may be deployed on an edge server disposed in area B. The in-vehicle device 10 can obtain this regional information for the area in which the own vehicle is situated by identifying the edge server corresponding to that area, and accessing the external agent provided by this edge server.

Also, processing described as being performed by one device may be shared and executed by a plurality of devices. Alternatively, processing described as being performed by different devices may be executed by one device. In a computer system, what sort of hardware configuration (server configuration) is used to realize each function can be flexibly changed.

The present disclosure can also be realized by supplying a computer with a computer program that implements the functions described in the above embodiment, and causing one or more processors of this computer to read and execute the program. Such a computer program may be provided to the computer by a non-transitory computer-readable storage medium connectable to a system bus of the computer, or may be provided to the computer via a network. Examples of a non-transitory computer-readable storage medium include a disc of any type such as a magnetic disc (floppy (registered trademark) disc, hard disk drive (HDD), etc.), an optical disc (compact disc (CD)-ROM, digital versatile disc (DVD), Blu-ray disc, etc.) and so forth, ROM, RAM, EPROM, electrically erasable programmable read only memory (EEPROM), a magnetic card, flash memory, an optical card, and any type of medium suitable for storing electronic commands.

What is claimed is:

1. An information processing device comprising:
a control unit that executes
acquiring an utterance sentence based on an utterance made by a user,
deciding, based on the utterance sentence, one or more external agents to which the utterance sentence is to be transmitted, from among a plurality of external agents each providing a dialogue service in natural language and each specialized in one of a plurality of predetermined domains, respectively,
transmitting the utterance sentence to the one or more external agents that are decided upon, and acquiring one or more responses from the one or more external agents, and
integrating the one or more responses and providing a response that is integrated to the user, wherein
the control unit
decides, based on scores respectively set for the external agents, the one or more external agents to which the utterance sentence is to be transmitted, or decides, based on the scores, which of the one or more responses are to be objects of the integration, and
updates the scores corresponding to at least one of the one or more external agents, based on behavior of the user following providing of the response that is integrated.

2. The information processing device according to claim 1, wherein
the control unit further
acquires feedback data indicating behavior of the user following providing of the response that is integrated, and
updates a score based on the feedback data.

3. The information processing device according to claim 2, wherein, when the feedback data indicates that the user is positive regarding a response from a first external agent, the control unit raises the score for the first external agent.

4. The information processing device according to claim 2, wherein, when the feedback data indicates that the user is negative regarding a response from a first external agent, the control unit lowers the score for the first external agent.

5. The information processing device according to claim 2, wherein the feedback data includes data indicating places visited by the user, or content of utterances of the user.
